(19) United States
(12) Patent Application Publication
(10) Pub. No.: US 2016/0370403 A1
(43) Pub. Date: Dec. 22, 2016

(54) CAPACITIVE ACCELEROMETER DEVICES AND WAFER LEVEL VACUUM ENCAPSULATION METHODS

(71) Applicants: ADEL MERDASSI, ARIANA (TN); VAMSY CHODAVARAPU, VERDUN (CA); MOHAMAD NIZAR KEZZO, MONTREAL (CA)

(72) Inventors: ADEL MERDASSI, ARIANA (TN); VAMSY CHODAVARAPU, VERDUN (CA); MOHAMAD NIZAR KEZZO, MONTREAL (CA)

(21) Appl. No.: 15/189,502

(22) Filed: Jun. 22, 2016

Related U.S. Application Data
(60) Provisional application No. 62/182,703, filed on Jun. 22, 2015.

(51) Int. Cl. G01P 15/125

(52) U.S. Cl. CPC G01P 15/125

(57) ABSTRACT

Silicon-based capacitive accelerometers are relatively simple to fabricate and offer low cost, small size, low power, low noise and provide high sensitivity, good DC response, low drift, and low temperature sensitivity. However, tri-axial accelerometers, as opposed to using multiple discrete accelerometers, require very low cross-axis sensitivity and close sensitivities across the three directions. It would be beneficial to provide a design methodology for such tri-axial accelerometers which is compatible with commercial MEMS manufacturing processes in order to remove requirements for device specific processing, non-standard processing, etc. Accordingly, tri-axial accelerometers with low cross axis sensitivity have been established exploiting decoupled frames in conjunction with axis specific spring designs. Further, exploitation of differential capacitive transduction using an asymmetric configuration for in-plane measurements along X- and Y-axis and an absolute measurement along Z-axis allows the manufacturing upon a commercial MEMS foundry process.

### CROSS-REFERENCE TO RELATED APPLICATIONS

This application claims the benefit of priority from U.S. Provisional Patent Application Ser. No. 62/182,703 filed Jun. 22, 2015 entitled “Capacitive Accelerometer Devices and Wafer Level Vacuum Encapsulation Methods” the entire contents of which are included herein by cross-reference.

### FIELD OF THE INVENTION

This invention relates to MEMS based capacitive accelerometers and more particularly to multiple axis accelerometers with low cross-axis sensitivity and compatibility with commercial wafer level encapsulation and MEMS fabrication processes.

### BACKGROUND OF THE INVENTION

The market potential for silicon-based low cost, miniaturized and low power multi-axis Micro-Electro-Mechanical System (MEMS) accelerometers is growing rapidly and these sensors are found in a variety applications including smartphones, gaming devices, digital cameras, automobiles, wearable devices, structural health monitoring, energy exploration and industrial manufacturing. Many leading and emerging semiconductor companies are currently marketing silicon based tri-axial accelerometers and the development of silicon based tri-axial accelerometers has been extensively studied by several research groups using various custom or proprietary microfabrication processes with surface micromachining, bulk micromachining, combined surface and bulk micromachining, and Complementary Metal-Oxide-Semiconductor (CMOS) MEMS processes.

Silicon-based capacitive accelerometers are relatively simple to fabricate and offer low cost, small size, low power, low noise and provide high sensitivity, good DC response, low drift, and low temperature sensitivity. Tri-axial accelerometers, as opposed to the use of multiple discrete accelerometers, require very low cross-axis sensitivity and close sensitivities across the three directions. Accordingly, it would be beneficial to provide such tri-axial accelerometers using a commercial MEMS manufacturing process in order to remove requirements for device specific processing, non-standard processing, etc.

It would be further beneficial to provide such tri-axial accelerometers using a commercial MEMS manufacturing process that supports wafer level vacuum encapsulation of the MEMS devices. Wafer level vacuum encapsulation of MEMS devices plays a key role in improving the sensor performance and long term reliability. Further, wafer level vacuum encapsulation can provide extraordinary benefits in comparison to the existing state-of-the-art microfabrication processes for the development of MEMS sensors in reducing the overall product cost, simplifying packaging constraints, and easing supply-chain logistics. The encapsulation of vibrational inertial MEMS sensors such as accelerometers with a pressure below atmospheric pressure influences quality factor, response time, stiction, damping and humidity exposure

Accordingly, the inventors have established a strategic new design methodology to provide this beneficial low cross axis sensitivity via decoupled frames. Further, by exploiting a differential capacitive transduction using asymmetric configuration for in-plane measurement along X- and Y-axis and an absolute measurement along Z-axis the inventors beneficially provide such as tri-axial accelerometer upon a commercial MEMS foundry process.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations in the prior art relating to MEMS based capacitive accelerometers and more particularly to multiple axis accelerometers with low cross-axis sensitivity and compatibility with commercial wafer level encapsulation and MEMS fabrication processes.

In accordance with an embodiment of the invention there is provided a device comprising:
a substrate;
a microelectromechanical system (MEMS) comprising a plurality of integer N frames disposed within each other with the inner N−1 frames being suspended with respect to the substrate, the outermost frame attached to the substrate, and the innermost frame providing a proof mass;
a plurality of N−1 sets of springs, each set of springs being of a predetermined design and attached from a first predetermined frame of the plurality of N frames to a second predetermined frame of the plurality of N frames;
a plurality of M comb drive pairs, each comb drive pair comprising first and second comb drives attached at opposite sides of a third predetermined frame of the plurality of N frames to a fourth predetermined frame of the plurality of N frames.

In accordance with an embodiment of the invention there is provided a device comprising:
a fixed frame;
a first frame disposed within an opening within the fixed frame connected to the fixed frame by a plurality of first springs;
a second frame disposed within an opening within the first frame connected to the first frame by a plurality of second springs;
a proof mass disposed within an opening within the second frame connected to the second frame by a plurality of third springs; wherein
each of the first and second frames have a first axis of the respective frame longer than a second axis of the respective frame and the first axes of the first and second frames are orthogonal to each other.

In accordance with an embodiment of the invention there is provided a method comprising:
linking a proof mass to a first frame by a plurality of first springs that support motion of the proof mass out of the plane within which the proof mass and the plurality of first springs are manufactured;
linking the first frame to an outer frame by a plurality of second springs that support motion of the first frame in the plane within which the first frame and the plurality of second springs are manufactured; and
providing a pair of drive combs attached to the outer frame.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts schematically the structural design of a tri-axial accelerometer sensor with decoupled frames according to an embodiment of the invention;

FIGS. 2A and 2B respectively depict 3D models of the complete accelerometer sensor and partial sensor showing only the fixed and decoupled frame structures respectively according to embodiments of the invention;

FIGS. 2C and 2D depict schematically the structures of the spring elements employed within an accelerometer sensor according to an embodiment of the invention;

FIGS. 2E and 2F depict electrical transduction mechanisms of differential capacitance measurement with asymmetric comb-finger configuration along X- and Y-axes and absolute capacitance measurement along Z-axis;

FIGS. 3A depicts schematically the structural design of a tri-axial accelerometer sensor with decoupled frames according to an embodiment of the invention;

FIG. 3B depicts schematically the springs within the tri-axial accelerometer of FIG. 3A for each of the X-axis, Y-axis and Z-axis respectively;

FIG. 4A depicts a low cross-axis sensitivity technique with extended top electrode along X- and Y-axes according to an embodiment of the invention;

FIG. 4B depicts a low cross-axis sensitivity technique with recessed fingers with 4 μm height difference according to an embodiment of the invention;

FIG. 4C depicts a low cross-axis sensitivity technique capacitive inter-digitated compensation electrodes according to an embodiment of the invention;

FIGS. 5A, 5B and 5C respectively depict Finite Element Method analysis of in-plane X- and Y-axes modes and out-of-plane Z-axis mode for a tri-axial accelerometer sensor with decoupled frames according to an embodiment of the invention;

FIGS. 6A and 6B respectively depict frequency-domain analysis via lumped element modelling for a tri-axial accelerometer sensor with decoupled frames according to an embodiment of the invention;

FIGS. 7A, 7B and 7C respectively depict simulated calibration curves for differential measurements along the X- and Y-axes and absolute measurement in the Z-axis for a tri-axial accelerometer sensor with decoupled frames according to an embodiment of the invention;

FIGS. 8A, 8B, 8C and 8D respectively depict damping force and coefficient for the central proof mass arising from the squeezed effect and slide air-film effect for a tri-axial accelerometer sensor with decoupled frames according to an embodiment of the invention;

FIG. 9A depicts cross-section views of the layers employed in the tri-axial accelerometer sensor manufacture according to an embodiment of the invention;

FIG. 9B depicts a cross-sectional optical micrograph of a fabricated inertial tri-axial accelerometer sensor;

FIGS. 10A, 10B, 10C and 10D depict the experimental setup for testing tri-axial accelerometer sensors according to embodiments of the invention;

FIGS. 11A, 11B and 11C respectively depict experimental results for a tri-axial accelerometer sensor manufacture according to an embodiment of the invention in the X-, Y- and Z-axes;

FIGS. 12A, 12B, 12C, 12D, 12E and 12F depict experimental results for evaluating the cross-axis sensitivity of a tri-axial accelerometer sensor manufacture according to an embodiment of the invention by testing at 45° to different pairs of the X-, Y- and Z-axes; and

FIG. 13 depicts a total equivalent noise (TENA) measurement of an accelerometer according to an embodiment of the invention performed under 1 g input acceleration.

### DETAILED DESCRIPTION

The present invention is directed to MEMS based capacitive accelerometers and more particularly to multiple axis accelerometers with low cross-axis sensitivity and compatibility with commercial wafer level encapsulation and MEMS fabrication processes.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

0. Background

Within the prior art accelerometers have been implemented not only on research semiconductor processing lines but also upon unmodified commercial Micro-Electro-Mechanical System (MEMS) processes such as MEMSCAP's Multi-User MEMS Processes (MUMPS), Sandia National Laboratories' SUMMiT V, IMEC's SiGe, and STMicroelectronics' ThELMA. In contrast, the Teledyne DALSA MEMS Integrated Design for Inertial Sensors (MIDIS) process is not only a commercial MEMS process but it also includes ultra-clean wafer level vacuum encapsulation of the MEMS devices. Wafer level vacuum encapsulation of MEMS devices is currently extensively studied by various research groups as it plays a key role in improving both performance and long term reliability of the sensor. The availability of wafer level vacuum encapsulation processing provides benefits in reducing the overall product cost, simplifying packaging constraints, and easing supply-chain logistics. The encapsulation of vibrational inertial MEMS sensors such as accelerometers with a pressure below atmospheric pressure also influences quality factor, response time, stiction, damping and humidity exposure. Whilst wafer level vacuum packaging of MEMS accelerometers has been demonstrated within the prior art using custom microfabrication processes. In contrast, the inventors employ wafer level vacuum packaging of MEMS accelerometers in a high volume commercial MEMS process. The commercial MIDIS process is based on high aspect ratio bulk micromachining of single-crystal silicon wafer (referred to as the device layer within this specification) that can either be vacuum encapsulated at 10 mTorr or at sub-atmospheric pressure of 150 Torr between two other silicon wafers (referred to as top interconnect and bottom handling wafers within this specification). The achievable total leak rate equivalent in the MIDIS process is 45 molecules/s (7.5×10⁻¹³ atm·cm³/s). The top silicon wafer includes Through Silicon Vias (TSVs) with sealed anchors for compact flip-chip integration and interconnection with external microelectronic signal processing circuitry. Within the following description the inventors present a tri-axial accelerometer sensor permitting simultaneous acceleration detection along the 3 principal axes (X, Y and Z).

In order to achieve this the inventors have established a novel design for the decoupled frames as well as established out-of-plane measurements upon a MIDIS process specifically optimized for in-plane inertial sensors. In order to decouple the frames, the inventors established different kinds of spring structures that are made selectively more sensitive across one specific axis of input acceleration. Further, as described and depicted below the novel methodology exploits recessed comb-fingers that are used to enable sensing along the Z-direction. Accordingly, tri-axial accelerometers according to embodiments of the invention employ differential capacitive transduction using asymmetric configurations for the measurements along the X- and Y-axes which are in-plane and absolute measurement along Z-axis, i.e. out of plane. Accordingly, tri-axial accelerometers according to embodiments of the invention may be interfaced to capacitance to digital converter circuits such as those implemented in CMOS allowing direct CMOS-MEMS integration methodologies to be supported.

1. Accelerometer Sensor Design

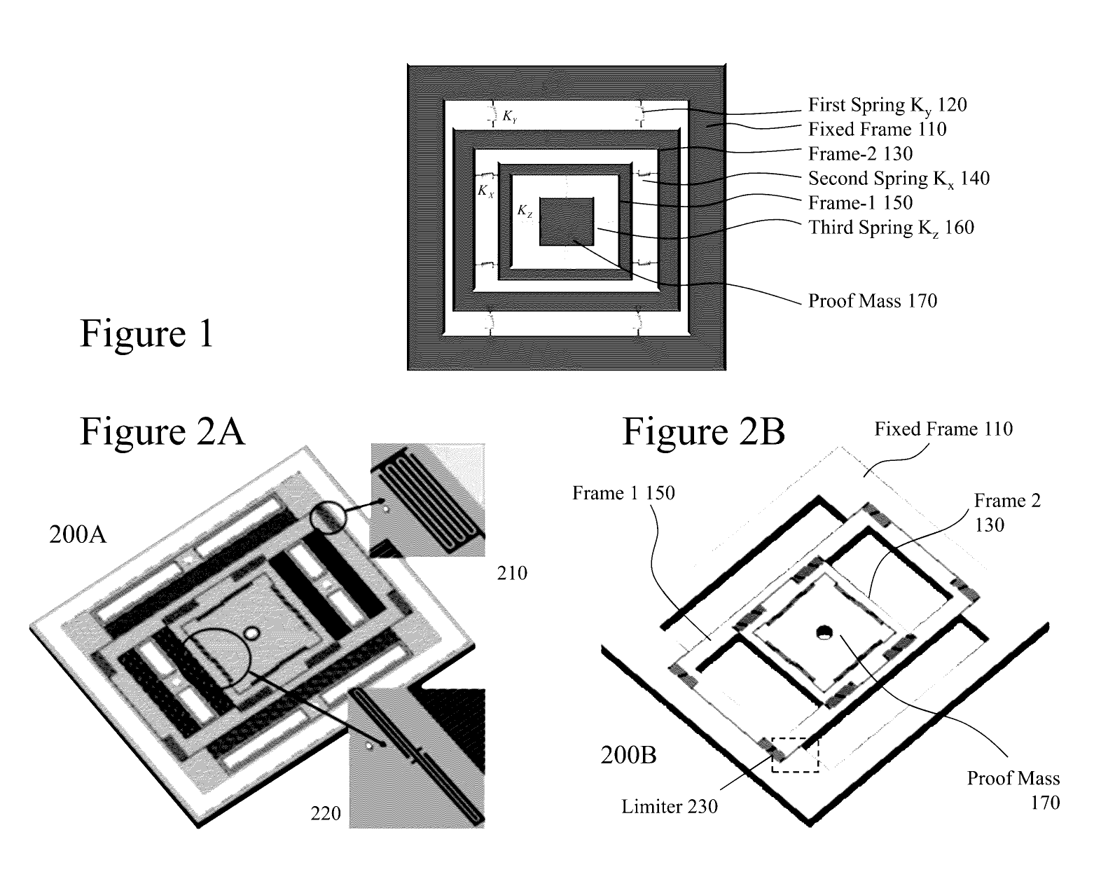

Referring to FIG. 1 there is depicted schematically the design of a proposed tri-axial accelerometer according to an embodiment of the invention. The design consists of a central Proof Mass 170 supported by multiple frames, Fixed Frame 110, Frame-1 150 and Frame-2 130, that are connected to each other by different kinds of spring structures. The accelerometer uses a single central Proof Mass 170 structure moving along the main principle axes which reduces the total dimensional area of the inertial sensor. The central proof mass, the Frame-1 150 and Frame-2 130 are sensitive to Z-, X- and Y-axis directions, respectively. Thus, each axis can be modeled by a spring-mass system with its associated damping coefficients, bₓ;b_{y};b_{z} along X-, Y- and Z-axis, respectively, as given by Equation (1). Each mass component, mₓ;m_{y};m_{z} experiences a stimulus force due to the applied accelerations, aₓ;a_{y};a_{z}, along X-, Y- and Z-axis, respectively, generating a small displacement that can be converted into electrical measurements. Within the embodiments of the invention described below two mechanisms are employed for converting displacement to an electrical parameter variation that can be measured. These are differential capacitance measurements along the X- and Y-axis and absolute capacitance measurements along the Z-axis. The transmissibility function, T(jω), between the acceleration and the displacement is expressed by Equation (2), where, ω₀ is the natural frequency and ξ is the damping ratio.

$$\begin{matrix}( \begin{matrix}{m}_{x} & 0 & 0 \\ 0 & {m}_{y} & 0 \\ 0 & 0 & {m}_{z}\end{matrix} ) ( \begin{matrix}\ddot{x} \\ \ddot{y} \\ \ddot{z}\end{matrix} ) + ( \begin{matrix}{b}_{x} & 0 & 0 \\ 0 & {b}_{y} & 0 \\ 0 & 0 & {b}_{z}\end{matrix} ) ( \begin{matrix}\dot{x} \\ \dot{y} \\ \dot{z}\end{matrix} ) ( \begin{matrix}{k}_{x} & 0 & 0 \\ 0 & {k}_{y} & 0 \\ 0 & 0 & {k}_{z}\end{matrix} ) ( \begin{matrix}x \\ y \\ z\end{matrix} ) = ( \begin{matrix}{m}_{x} & {a}_{x} \\ {m}_{y} & {a}_{y} \\ {m}_{z} & {a}_{z}\end{matrix} ) & ( 1 ) \\ T ( j ω ) = \frac{\frac{1}{{ω}_{0}^{2}}}{\sqrt{{( 1 - \frac{{ω}^{2}}{{ω}_{0}^{2}} )}^{2} + {( 2 ξ \frac{ω}{{ω}_{0}} )}^{2}}} & ( 2 )\end{matrix}$$

1.1. Electro-Mechanical Design

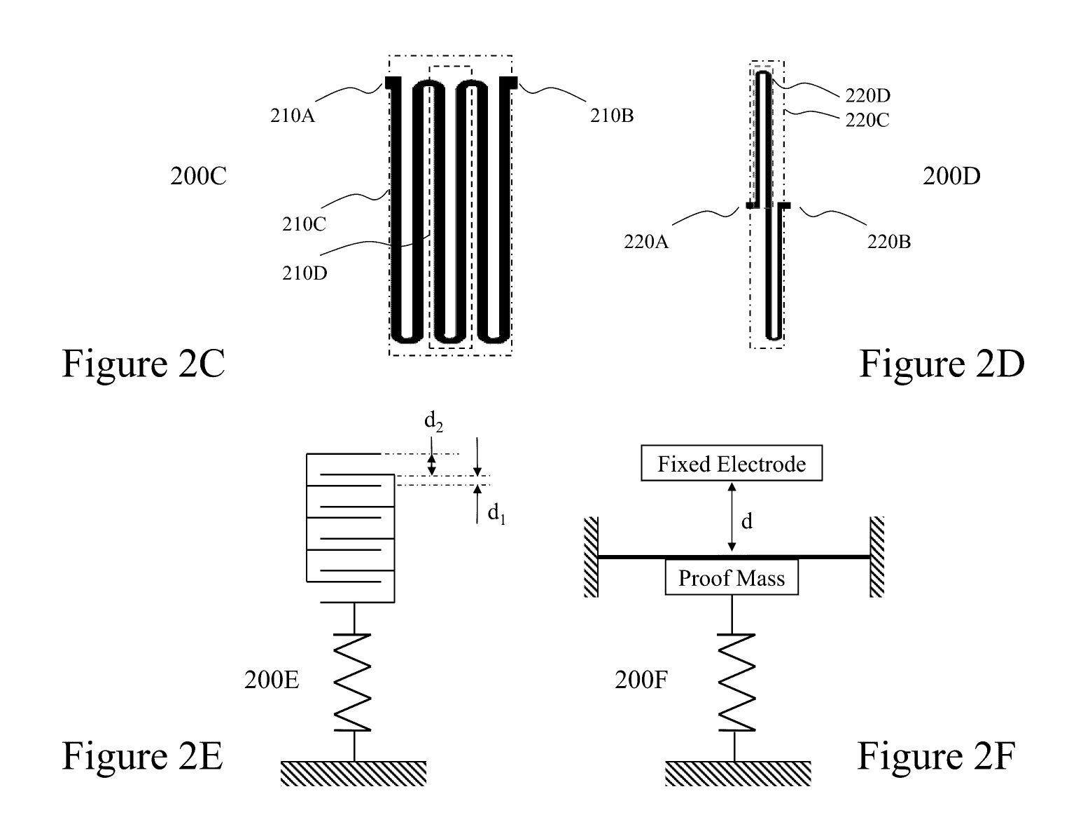

Now referring to FIG. 2A in first image 200A a three-dimensional (3D) model of the device structure is depicted together with first and second close-up views of the first and second spring structures 210 and 220 in the top-right and bottom-right corners that are used to support the three different masses. These first and second structures 210 and 220 respectively are depicted in isolation in FIGS. 2C and 2D respectively as third and fourth images 200C and 200D respectively. The central proof mass has a square shape to allow uniform out-of-plane motion sensing. The fixed and decoupled frames have a rectangular shape enabling more sensitive in-plane motion sensing along each specific axis. The device thickness is fixed by the

MEMS fabrication process at 30 μm. The large size of the proof mass helps to reduce the noise and increase the sensitivity of the accelerometer. At low operational frequencies (f<<f₀), the mechanical sensitivity, S_{MECH}, is inversely proportional to the natural frequency, f₀, for each axis and is given by the Equation (3), where, Δx is the displacement for a specific variation of the input acceleration, Δa.

$${S}_{MECH} = \frac{Δ x}{Δ a} = \frac{1}{{( 2 π {f}_{0} )}^{2}} \qquad ( 3 )$$

The springs supporting the Proof Mass 170 and moveable (decoupled) frame structures Frame-1 150 and Frame-2 130 each consist of four flexible springs supporting the inner element from its outer element. However, the inventors have established a novel configuration of these springs such that they are made selectively more sensitive across one specific axis of input acceleration and reduce cross-coupling to the other axes of input acceleration.

First Spring 210: This comprises first and second Mounts 210A and 210B disposed at one side of the first Spring 210. Between these first and second Mounts 210A and 210B is a first Serpentine 210C comprised of a number of first U-Springs 210D disposed sequentially. These are connected in series at one common side, such that first U-Springs 210D are disposed to one common side of a line joining the first and second mounts 210A and 210B.

Second Spring 220: This comprises third and fourth Mounts 220A and 220B which are centrally disposed with respect to second Spring 220. Between these third and fourth Mounts 220A and 220B is a second Serpentine 220C comprised of a number of second U-Springs 220D. These are disposed sequentially in series and alternate, such that the second U-Springs 220D are disposed alternately either side of a line joining the third and fourth Mounts 220A or 220B. Within the embodiments of the invention presented with respect to FIGS. 1 to 13 the number of second U-Springs 220D is two.

Spring Set 1: Frame-1 150 has four third Springs 160 of spring constant K_{z} attached to the central Proof Mass 170. Each of these springs is a second Spring 220 disposed at the mid-point of each edge of the square proof mass.

Spring Set 2: Frame-2 130 has four second Springs 140 of spring constant Kₓ attached to Frame-1 150. Each of these springs is a first Spring 210 and these are disposed in pairs along two edges of Frame-1 150 to Frame-2 130 starting from a corner of Frame-1 150 towards the middle of the edge they are disposed upon. With Frame-1 130 being rectangular with larger dimension along the X-axis these four Springs 140 are disposed on the short edge of Frame-1 150 and along the long edge of Frame-2 130.

Spring Set 3: Fixed Frame 110 has four first Springs 120 of spring constant K_{Y} attached to Frame-2 130. Each of these springs is a first Spring 210 and these are disposed in pairs along two edges of Fixed Frame 110 to Frame-2 130 starting from a corner of Frame-2 130 towards the middle of the edge they are disposed upon. With Frame-2 110 being rectangular with larger dimension along the Y-axis these four Springs 120 are disposed on the short edge of Frame-2 130 to the Fixed Frame 110. The Fixed Frame 110 is also patterned such that a portion of it runs along the long edges of Frame-2 130 near the four first Springs 120 to form Limiters 230 which based upon their dimension may limit the X-axis motion of the Frame 2 130.

In each case of first to third Springs 120, 140 and 160 their corners within the first Serpentine 210C are filleted to reduce the stresses due to elevated processing temperatures, especially, during the bonding process. The Proof Mass 170 as depicted is square in order to improve uniform out-of-plane sensing (i.e. vertical motion in Z-axis). In contrast Frame-1 150 and Frame-2 130 are rectangular in order to enhance their sensitivity in their respective directions. Similarly, the performance variations in the spring designs selected between each pair of sequential frames aid motion within the respective axis whilst three decoupled masses, Proof Mass 170, Fame-1 150, and Frame-2 130 aids isolation of motion in all three planes as nothing is referenced to a fixed set of electrodes. This is particularly true for the X-axis where the sensing electrode and “fixed” electrodes are both free to move in the Y-direction.

Additionally, the inventors exploit comb drives on both sides of the Proof Mass 170 such that the overlapping area remains constant, independent of the out of plane motion. Further, exploitation of recessed fingers with a height difference means that the constant overlapping area is maintained independent of the vertical motion.

Based on the lumped modeling, the spring constants, K_{X} and K_{Y} along the X- and Y-axes, respectively and K_{Z} along Z axis can be expressed by Equations (4A) and (4B), where E,I,h,w,L represent Young's modulus, the inertial moment, the height, the width and the length for each beam, respectively. The aspect ratio of thickness to width is appropriately designed to insure high stiffness allowing only one movement along the intended specific axis.

$$\begin{matrix}{K}_{X \text{/} Y} = \frac{8 {EI}_{Z}}{{L}^{3}} = \frac{2 {Ehw}^{3}}{{L}^{3}} & ( 4 A ) \\ {K}_{Z} = \frac{24 {EI}_{Y}}{5 {L}^{3}} = \frac{2 {Eh}^{3} w}{5 {L}^{3}} & ( 4 B )\end{matrix}$$

Referring to FIGS. 2E and 2F respectively, the two electrical transduction mechanisms exploited by the inventors within the novel tri-axial accelerometer are depicted. First image 200E in FIG. 2E_depicts a differential capacitance measurement with asymmetric configuration through inter-digitated fingers of MEMS combs. This differential capacitance measurement is employed with two different gaps, d₁; d₂ along the X- and Y-axis respectively. In contrast, the electrical transduction is based on absolute measurement along the Z-axis with a gap, d, between two electrodes as depicted in second image 200F in FIG. 2F. For small displacements, the electrical sensitivities along the X- and Y-axes are expressed by Equation (5A) and along the Z-axis by Equation (5B). Here, the small gap d₁ between the inter-digitized fingers is fixed at d₁=2 μm and the optimal ratio between d₁ and d₂ is determined to be 6, i.e. d₂=6*d₁. The gap, d, between the top electrode and the central proof mass was similarly set at d=2 μm. The overall sensitivity of the sensor along the X- and Y-axes are expressed by Equation (6A) and along the Z-axis by Equation (6B).

$$\begin{matrix}{S}_{X \text{/} Y \text{-} ELECT} = {C}_{0} \frac{{d}_{2} - {d}_{1}}{{d}_{2} {d}_{1}} & ( 5 A ) \\ {S}_{Z \text{-} ELECT} = \frac{{C}_{0}}{d} & ( 5 B ) \\ {S}_{X \text{/} Y} = \frac{{C}_{0}}{{ω}_{0}^{2}} \frac{{d}_{2} - {d}_{1}}{{d}_{2} {d}_{1}} & ( 6 A ) \\ {S}_{Z} = \frac{{C}_{0}}{{ω}_{0}^{2} d} & ( 6 B )\end{matrix}$$

1.2. Cross-Axis Sensitivity

The output signal of the tri-axial accelerometer that uses a single proof-mass structure and performs simultaneous measurement across the three principle axes, can generally be expressed by Equation (7). Ideally, to achieve 0% (zero) cross-axis sensitivity (CrossSens), the matrix shown in Equation (7) should only have terms S_{XX};S_{YY};S_{ZZ} with remainder being equal to zero. Thus, the cross-axis sensitivity which is defined as the output induced on a sense axis from the application of acceleration on a perpendicular axis, expressed as a percentage of the sensitivity is given by Equations (8A) to (8C) respectively for X-, Y-, and Z-axes respectively.

$$\begin{matrix}( \begin{matrix}{S}_{XX} & {S}_{XY} & {S}_{XZ} \\ {S}_{YX} & {S}_{YY} & {S}_{YZ} \\ {S}_{ZX} & {S}_{ZY} & {S}_{ZZ}\end{matrix} ) ( \begin{matrix}{a}_{X} \\ {a}_{Y} \\ {a}_{Z}\end{matrix} ) = ( \begin{matrix}{V}_{X} \\ {V}_{Y} \\ {V}_{Z}\end{matrix} ) & ( 7 ) \\ {CrossSens}_{X} ( \% ) = ( \frac{\sqrt{{( {S}_{XY} - {S}_{Y} )}^{2} + {( {S}_{ZY} - {S}_{Y} )}^{2}}}{{S}_{Y}} ) \times 100 & ( 8 A ) \\ {CrossSens}_{X} ( \% ) = ( \frac{\sqrt{{( {S}_{YX} - {S}_{X} )}^{2} + {( {S}_{ZX} - {S}_{X} )}^{2}}}{{S}_{X}} ) \times 100 & ( 8 B ) \\ {CrossSens}_{X} ( \% ) = ( \frac{\sqrt{{( {S}_{XZ} - {S}_{Z} )}^{2} + {( {S}_{YZ} - {S}_{Z} )}^{2}}}{{S}_{Z}} ) \times 100 & ( 8 C )\end{matrix}$$

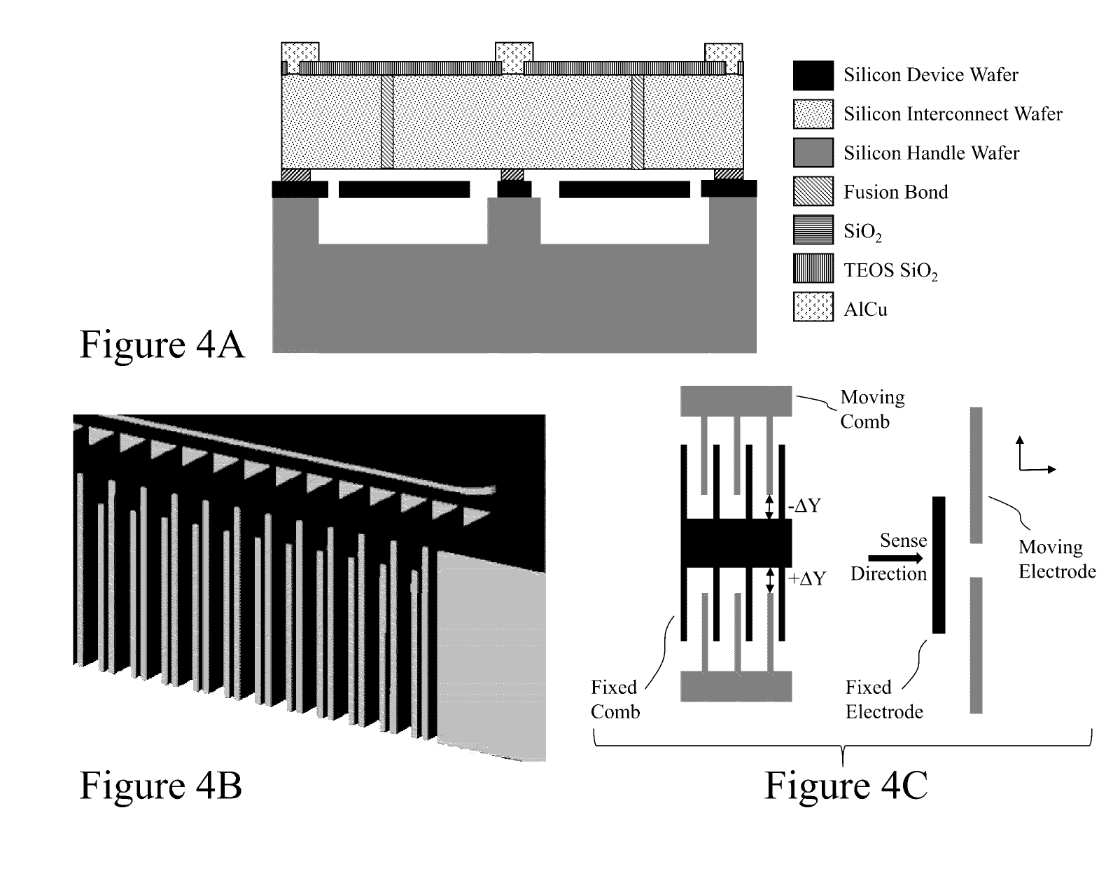

The capability to displace the central proof mass along Z-axis is achieved by the four Second Springs 220 where the stiffness is predominant over the First Springs 210. This allows dominant and unidirectional displacement of the bottom electrode. The area in the top wafer with Through Silicon Vias (TSVs) exceeds the central proof mass dimensions by 15 μm as shown in FIG. 4A, which is considered sufficient margin to enable the bottom electrode to move along X- or Y-axis without causing any DC offset in the electrical measurement that could lead to cross-axis sensitivity. Further, there is no effect of the vertical displacement from the inter-digitized fingers as the difference in the height between the fixed and the moving fingers is 4 μm, leading to null DC offset and thus leading to low cross-axis sensitivity as shown in FIG. 4B. The cross-axis sensitivity issue along X- and Y-axis is addressed through the use of two moving frames which permit the decoupling of the motion along the X- and Y-axis.

As shown in second image 200B in FIG. 2B, the Frame-1 150 is supported by Frame-2 130, and thus, there is negligible effect of the X-axis acceleration on the Frame-2 130. However, any movement in the Y-axis direction has direct effect on the Frame-1 150. Accordingly, this issue was mitigated by the inventors by employing another inter-digitized compensation capacitor, as shown in FIG. 4C, which keeps the same initial capacitance value regardless of the motion of the Frame-1 150 along the Y-axis. Thus, there is no mutual effect from the two frames on the output capacitance measurement which ultimately leads to low cross-axis sensitivity between a_{X} and a_{Y}.

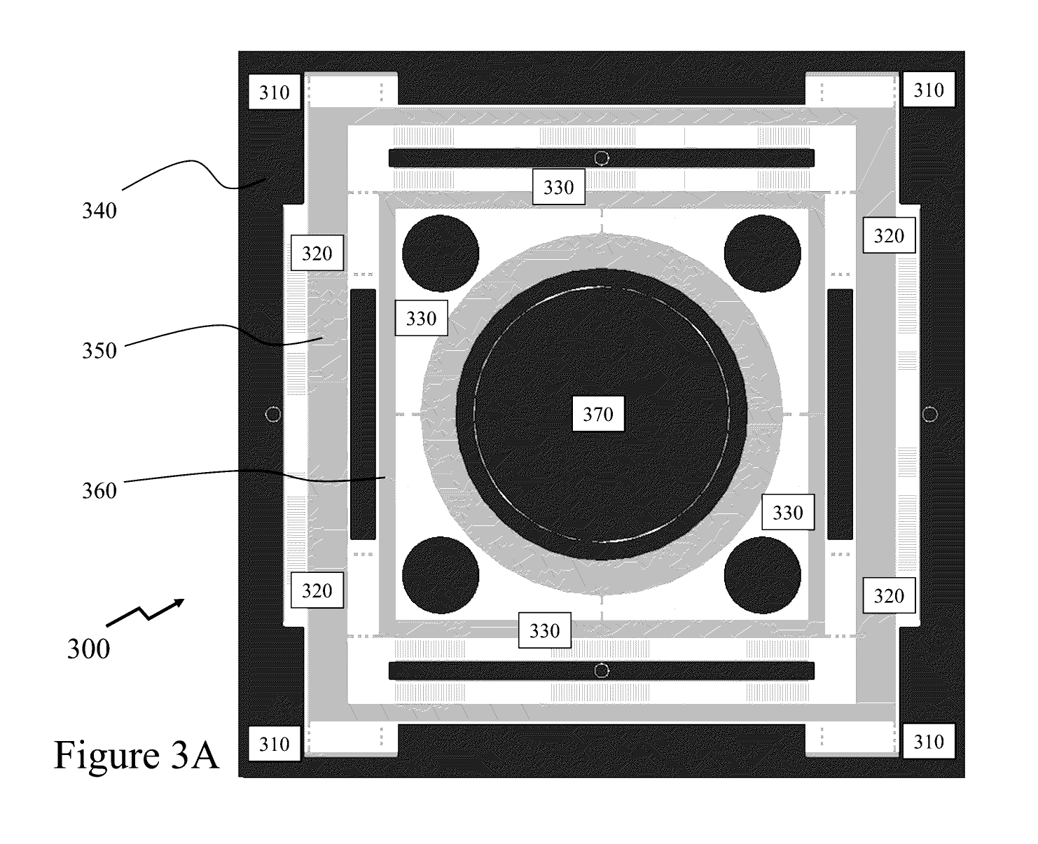

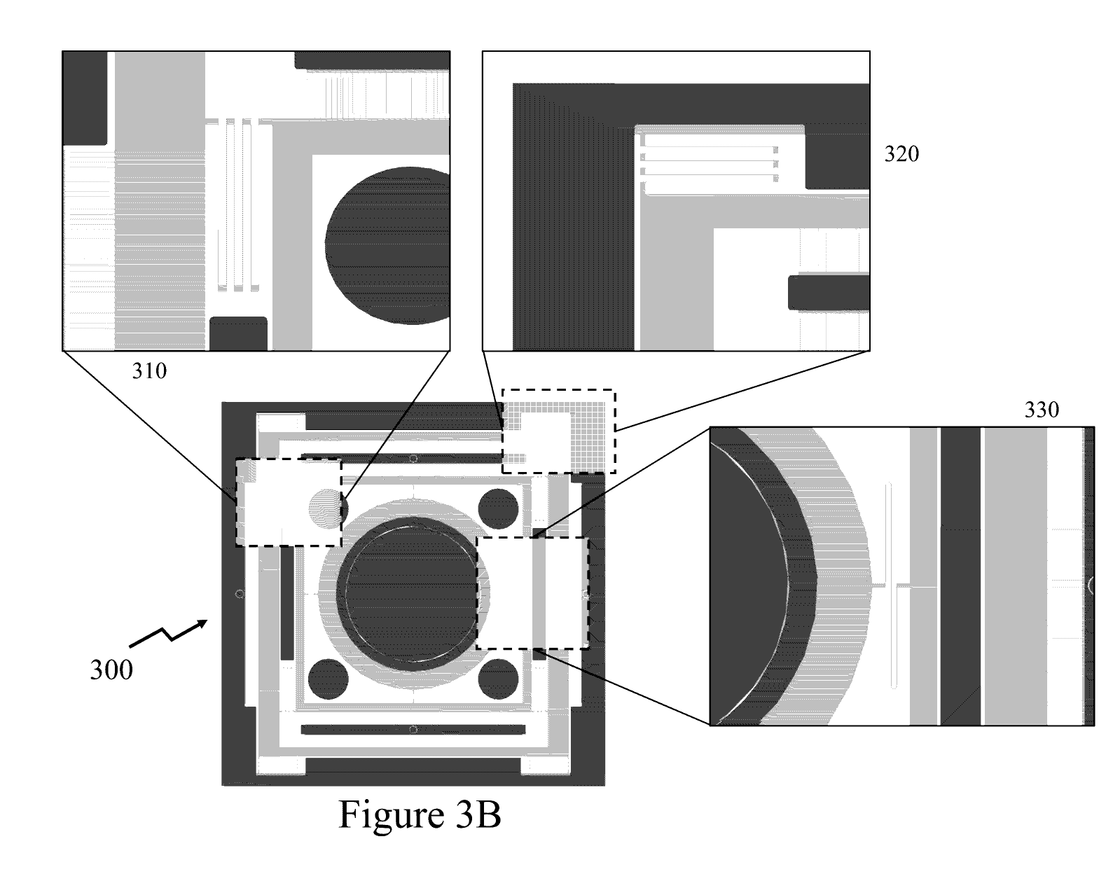

Now referring to FIG. 3A there is depicted a schematic 300A of a tri-axial accelerometer 300 according to an embodiment of the invention exploiting a similar nested sequence of Fixed Frame 340, first Free Frame 350, second Free Frame 360 and Proof Mass 370 wherein the first Free Frame 350 is connected to the Fixed Frame 340 via four Y-axis Springs 310. The second Free Frame 360 is disposed within the first Free Frame 350 and supported from it by four X-axis Springs 320. Similarly, the Proof Mass 370 is disposed within the second Free Frame 360 and supported from it by four Z-axis Springs 330. As evident in FIG. 3A the X-axis Springs 310 and Y-axis Spring 320 are located at the corner of the inner frame they support whereas the Z-axis Springs 330 are disposed at the center of the Proof Mass 370. In contrast to FIG. 1 the Proof Mass 370 is circular, the second free Frame 360 square, first Free Frame 350 slightly rectangular but could be square, and Fixed Frame 340 is similarly slightly rectangular but may also be square. Now referring to FIG. 3B enlarged images of X-axis Springs 310, Y-axis Springs 320, and Z-axis springs 330 with respect to the tri-axial accelerometer 300.

2. Simulation Results and Discussion

The simulations performed by the inventors consisted of modal and damping analysis using Finite Element Method (FEM) analysis with Coventorware software. The Architect module was used to perform lumped modeling where one could perform co-integration analysis combining signal conditioning circuitry and the sensor device.

2.1. Electromechanical Results

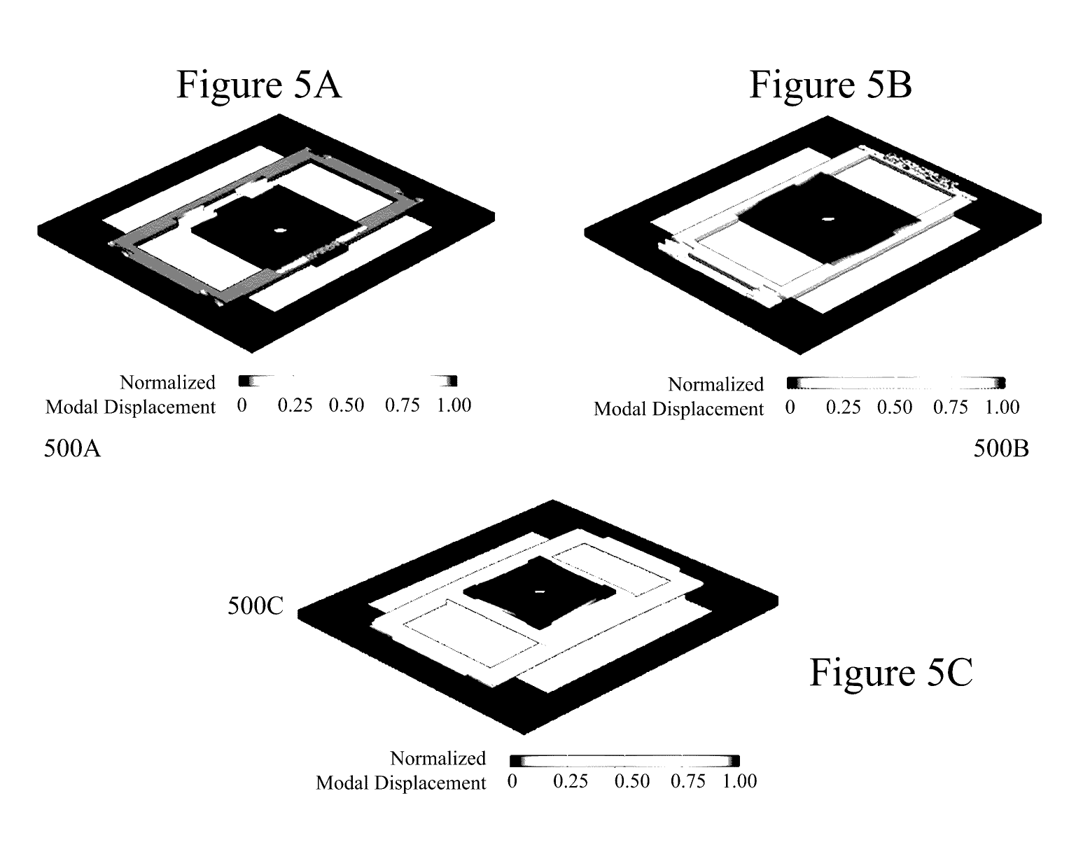

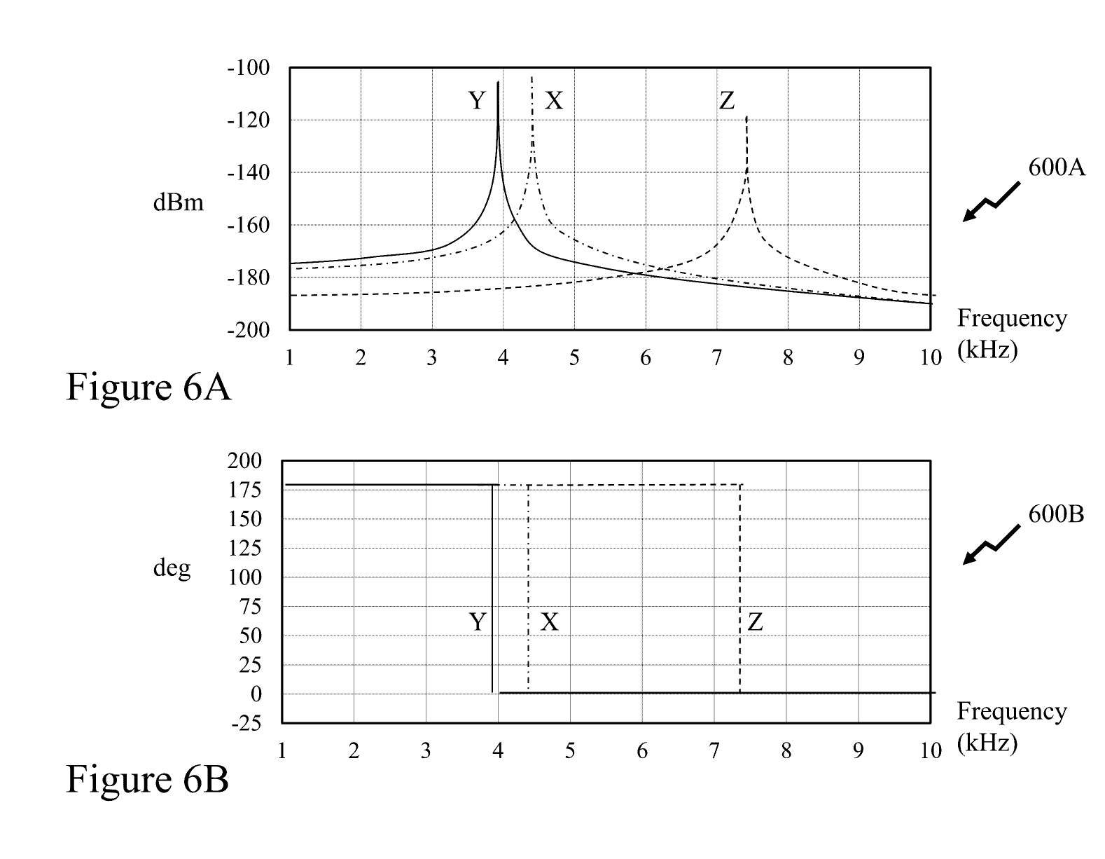

Modal analysis was used to show the dynamic characteristics of the sensor. The shapes for the first, second and third modes are illustrated in FIGS. 5A to 5C respectively with first to third images 500A to 500C respectively for X-, Y- and Z-axes respectively. The resonant frequencies along sensitive X-, Y- and Z-axes were designed to be [symbol] =4.37 kHz, [symbol] =4.16 kHz and [symbol] =8.37 kHz. Lumped modeling uses frequency analysis as illustrated in FIGS. 6A and 6B respectively depicting the amplitude 600A and the phase 600B respectively of the sensitive axis with resonant frequencies established around [symbol] =4 kHz, [symbol] =4.3 kHz, and [symbol] =7.3 kHz along the X-, Y- and Z-axes, respectively. The inventors note that the FEM method takes into account the rounded shapes of the springs as well as the complete structure shape. However, lumped modeling uses a perfect model for beams and structures which introduces a small difference between the two results.

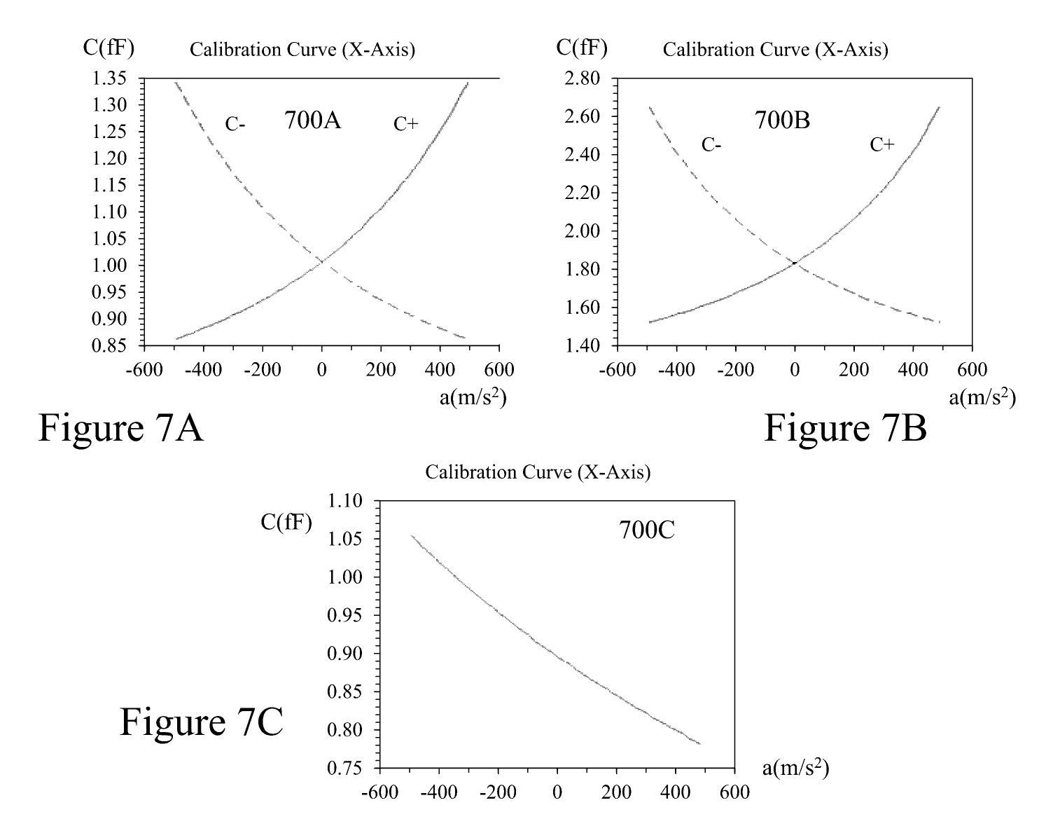

The capacitance measurement is based on differential measurement in order to increase the total capacitance change and consequently to improve the sensor sensitivity along the X- and Y-axis. The initial capacitances values of prototype tri-axial accelerometers according to an embodiment of the invention are C_{X}=2 pF, C_{Y}=2.7 pF, and C_{Z}=0.9 pF along the X-, Y- and Z-axes, respectively. Referring to FIGS. 7A to 7C respectively there are depicted the calibration curves 700A to 700C along the X-, Y-, and Z-axes respectively for the capacitance output versus the input acceleration for a prototype tri-axial accelerometers according to an embodiment of the invention. The maximum displacement for sensor comb structure is fixed at 25% from the initial gap d₁ in order to ensure an acceptable linearity over the [0-50 g] measurement range. First and second calibration curves 700A and 700B in FIGS. 7A and 7B contain two curves that represent the variation along each side of the inter-digitized comb fingers. Third calibration curve 700C in FIG. 7C represents only one curve as the measurement is absolute along Z-axis. The sensitivities, given by the slopes of each curve, for the prototype tri-axial accelerometers according to an embodiment of the invention were dC_{X}/dg=8.55 [symbol] F·g⁻¹, dC_{Y}/dg=18.03 [symbol] F·g⁻¹, and dC_{Z}/dg=2.64 [symbol] F·g⁻¹ with maximum ranges of 957 [symbol] F , 2.10 pF , and 269 [symbol] F along the X-, Y- and Z-axes, respectively.

2.2. Accelerometer Performance

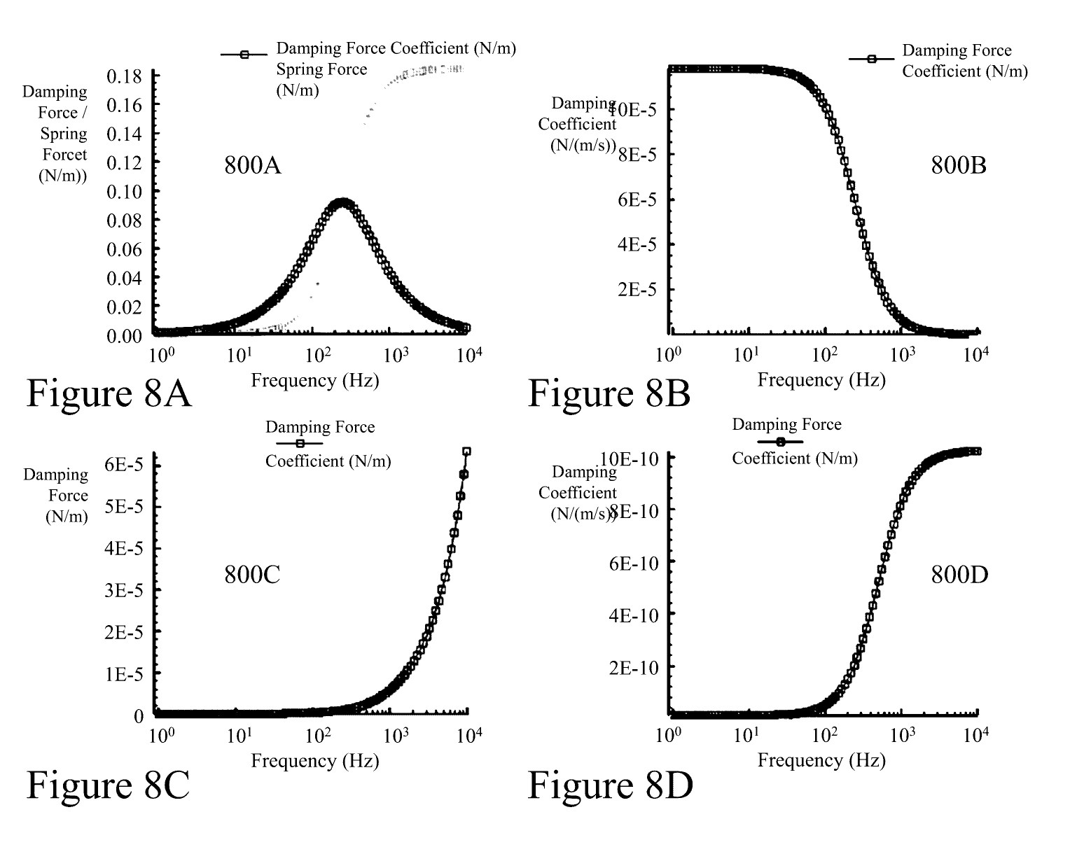

An underdamped response has the advantage of increasing the quality factor and thus achieving lower noise performance in an accelerometer. In addition, a higher Q-factor can help to improve the response time of the accelerometer. Both the vacuum maintained inside the sealed cavity and the device geometry control the damping coefficient and consequently the quality factor. The MIDIS commercial foundry process employed by the inventors offers encapsulation of the device wafer at 10 milliTorr vacuum. Further, the damping due to the geometry effect is analyzed by considering two main damping mechanisms, the slide air-film and the squeezed air-film damping, that are confined in the 2 μm gap between the central proof mass and the top wafer. FIGS. 8A to 8D respectively depict the results of the damping coefficient over the operating frequency range indicating the dominance of the squeezed airflow mechanism (0.092 μN/μm/μs) over the slide film damping (5.26 e⁻¹⁰ μN/μm/μs). Likewise, the effect of inter-digital fingers was analyzed using Stokes flow regime and the damping coefficients values established as 9.26 e⁻⁸ μN/μm/μs and 1.518 e⁻⁷ μN/μm/μs along X- and Y-axes, respectively. As depicted first graph 800A depicts damping force due to the squeezed effect, second graph 800B the damping coefficient from the squeezed effect, third graph 800C he damping force due to the size effect, and fourth graph 800D the damping force coefficient due to the size effect.

3. Experimental Results and Discussion

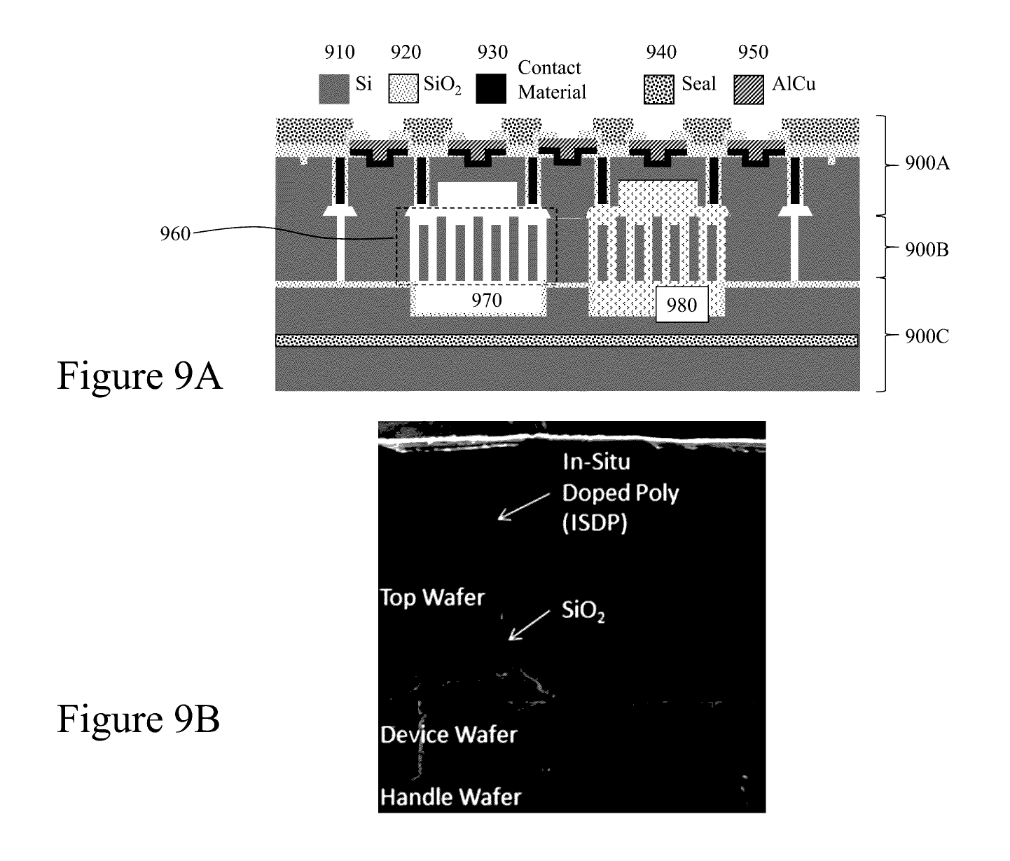

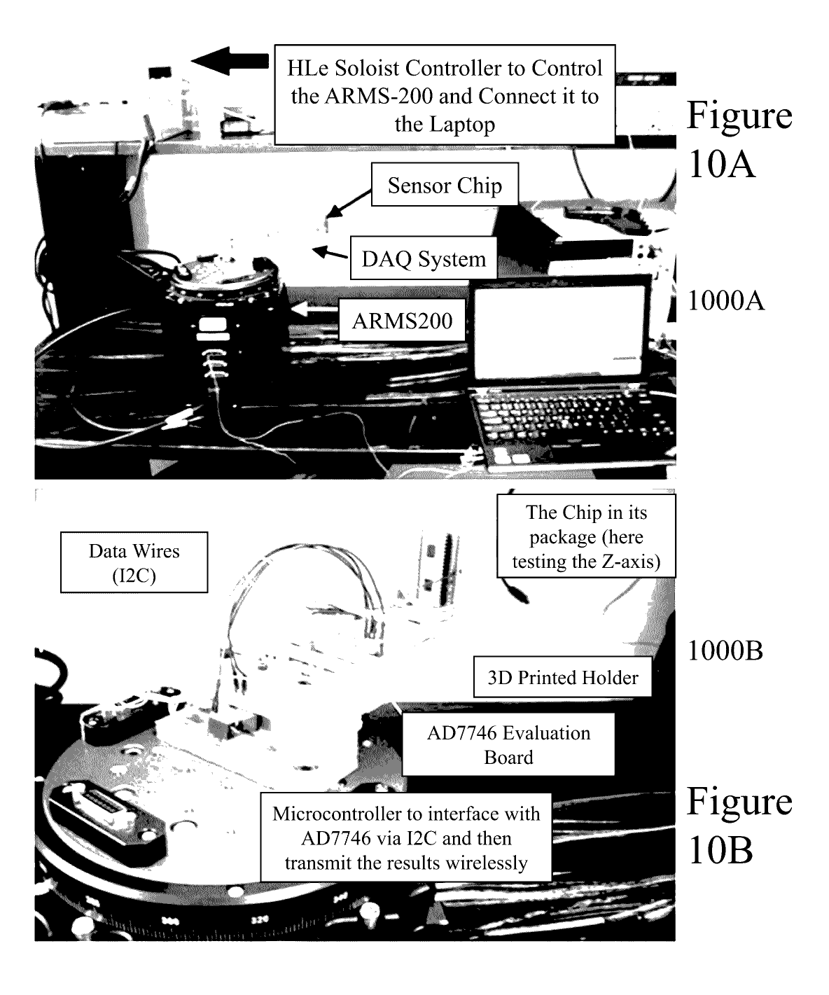

The prototype tri-axial accelerometers according to an embodiment of the invention were using the MEMS Integrated Design for Inertial Sensors (MIDIS) process from Teledyne DALSA Inc. which exploits a 30 μtm device wafer thickness. The cross-sectional view of a typical device fabricated with the commercial MEMS Integrated Design for Inertial Sensors process is depicted in FIG. 9A with the different layers involved in the device fabrication, namely silicon 910, silicon dioxide (SiO₂) 920, in-situ doped polysilicon (ISDP) 930, polymer 940, and AlCu 950. Also depicted at comb 960, first sealed cavity 970, e.g. at 10 mTorr “vacuum”, and a second seal cavity 980, e.g. at pressure such as 150 Torr , i.e. 150 Torr 1760 Torr≅0.2 atm. As depicted the prototype tri-axial accelerometers according to an embodiment of the invention are fabricated using a top layer 900A which is then bonded to a device layer 900B, which is 30 μm thick and within which the MEMS elements are formed, and handling layer 900C. Accordingly, bonding these three layers together provides the required sealed cavities around the MEMS elements. Now referring to FIG. 9B there is depicted an optical micrograph of the cross-section of the fabricated tri-axial accelerometer device. The TSV cap layer (top layer 900A) is bonded to the device layer 900B through thin intermediate conductive layer of 2 μm. Further, the commercial MIDIS process allowed the inventors to manufacture combs with recessed fingers having a height difference of 4 μm between the fixed comb and the moving comb as shown in FIG. 9A. These two features, namely a gap of 2 μtm between the two electrodes using oxide material as an insulating layer and recessed fingers with a height difference of 4 μm, were exploited to enable detection along Z-axis. Referring to Table 1 below design limits of the MIDIS MEMS process are defined within which prototype tri-axial accelerometers according to embodiments of the invention can be manufactured. It would, however, be evident to one of skill in the art that the prototype tri-axial accelerometers according to embodiments of the invention may be manufactured using other research and commercial MEMS processes although these may offer different design limits, design limitations and/or additional processing complexity to achieve the novel designs provided by prototype tri-axial accelerometers according to embodiments of the invention.

TABLE 1
MIDIS Fabrication Process Features

| | | Minimum | Minimum | Maximum |
|---|---|---|---|---|
| | Thickness | Feature | Spacing | Spacing |
| Feature | (μm) | (μm) | (μm) | (μm) |
| Device Wafer | 3 | 1.5 | 1.5 | — |
| Top Interconnect Wafer | 180 | 10 | 50 | — |
| Bonding Plane | 2 | 50 | 10 | 700 |
| Handling Wafer | 380 | 20 | 50 | — |

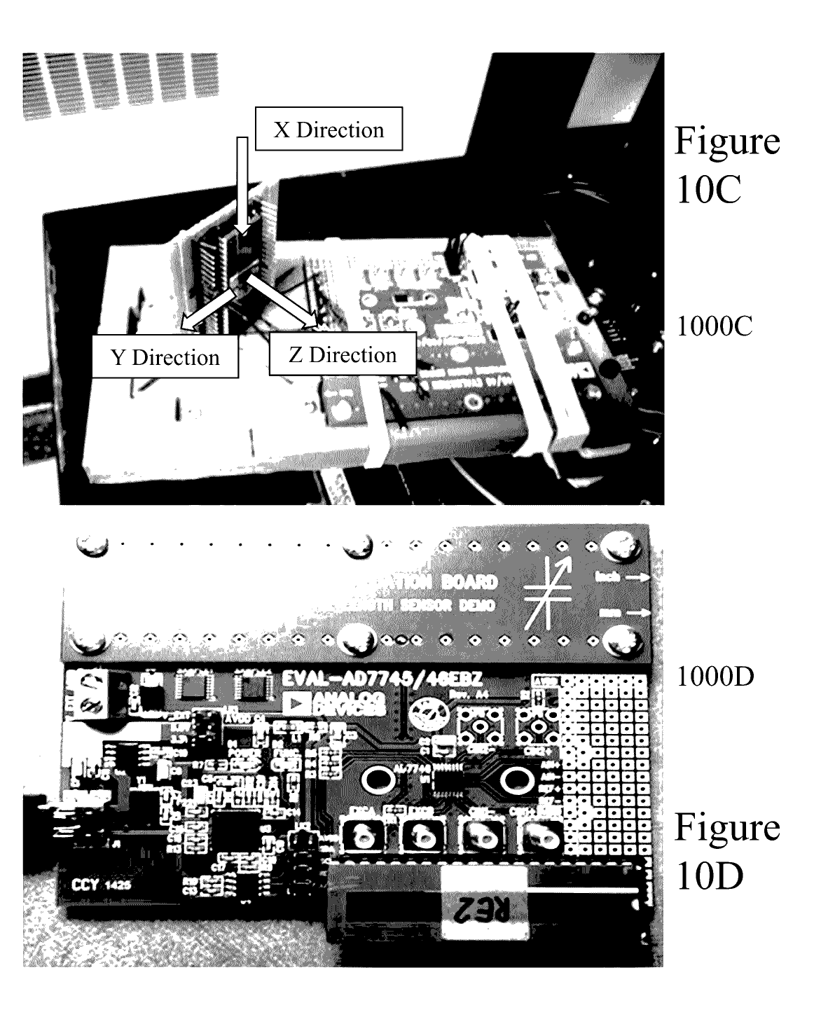

Referring to FIGS. 10A and 10B respectively there are depicted an experimental setup in first image 1000A of FIG. 10A for testing the sensor performance using a horizontal shaker ARMS-200 rotary motion simulator where sensor testing is performed by placing the chip in different positions along the principle axes (X, Y and Z) as shown in second image 1000B in FIG. 10B. In initial experiments, the measurements determined the sensor sensitivity and resolution along the various axes, while relying on the measured Total Noise Equivalent Acceleration (TENA). In subsequent experiments, the inventors performed experiments to measure cross-axis sensitivity performance by placing the accelerometer at 45° for each pair of axes (X,Y), (X,Z), and (Y,Z) as shown in third image 1000C in FIG. 10C, through which the acceleration components along two axes can be measured. Here, the objective is to compare the measured acceleration components in the second experiment to the value obtained from the first experiment. The sensor readout circuit employed was a 24-bit 2-channel Σ/Δ capacitance-to-digital convertor (AD7746 by Analog Devices Inc.) as evident from fourth image 1000D in FIG. 10D. The AD7746 includes an oversampling 24-bit Σ-Δ modulator and signal processing circuitry for noise shaping and filtering which helps to significantly minimize the noise and therefore enhances the measurement accuracy. The shaker allows acceleration only along one axis in range of 0-6 g. The AD7446 readout circuit was interfaced to a microcontroller via an I2C interface to transmit the acquired measurements to a computer.

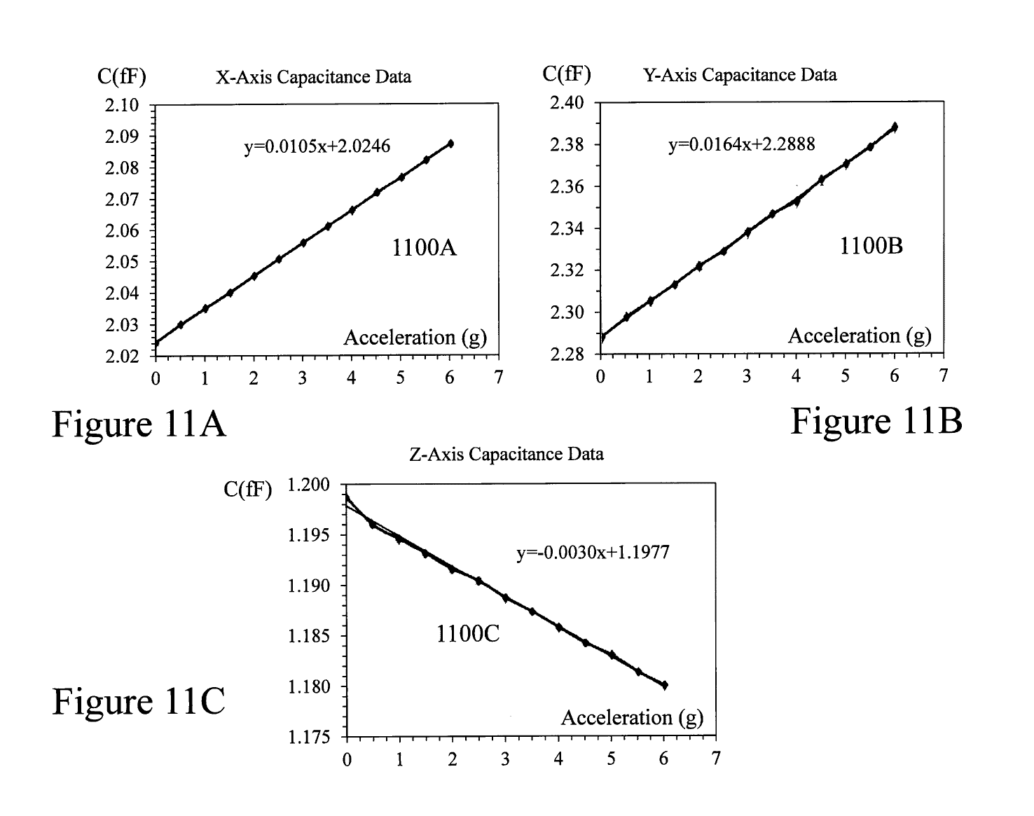

Referring to FIGS. 11A to 11C respectively there are illustrated the different calibration curves, that is, capacitance variation versus the input acceleration, with its linear regression curves through which the sensitivity was deduced from the slope. First to third images 1100A to 1100C in FIGS. 11A to 11C respectively depict the X-, Y-, and Z-axes respectively The experimental results in FIG. 11 are very close to the results found in the simulation studies. Sensitivity values of 10.5 [symbol] F·g⁻¹, 16.4 [symbol] F·g⁻¹ and 3 [symbol] F·g⁻¹ were obtained for the X-, Y- and Z-axes, respectively.

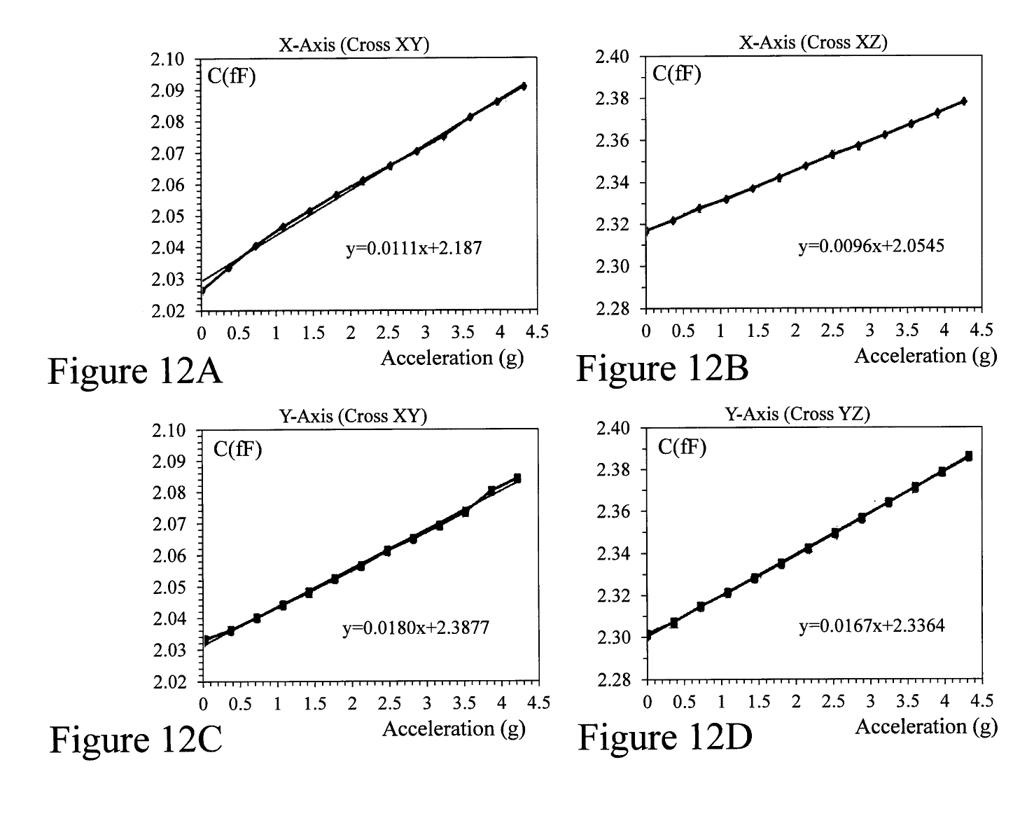

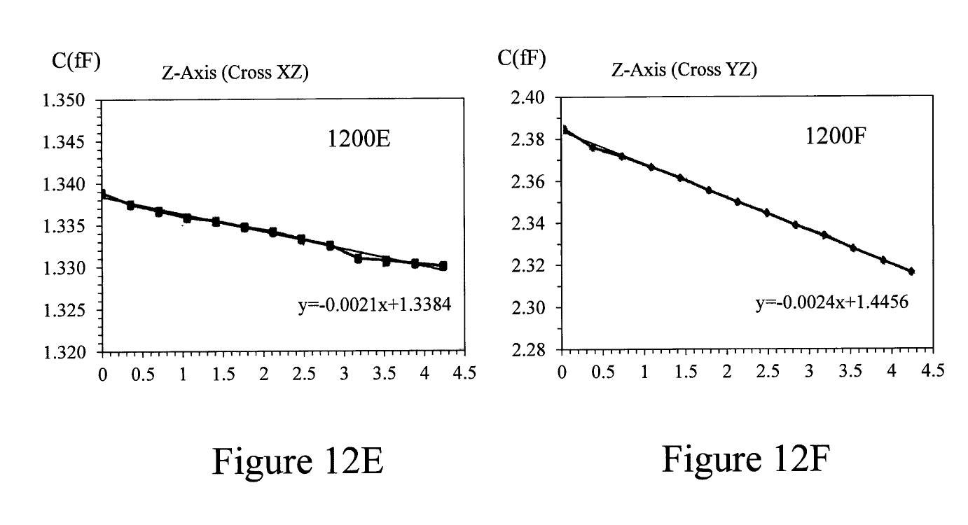

Now referring to FIGS. 12A to 12F respectively there are depicted experimental results for the calibration curves of each axis pair, namely (X,Y), (X,Z), and (Y,Z). The slope of the curve represents the sensor sensitivity and is extremely close to the values found in the case of single acceleration component where the sensor is directed along the radial axis. Here, the small differences in the experimental results can be explained by the noise generated due to the electric motor in the ARMS-200 rotary motion simulator. Table 2 summarizes the important specifications that describe the novel tri-axial accelerometer sensor implemented according to an embodiment of the invention. As depicted in FIGS. 12A to 12F the images_are:
First image 1200A in FIG. 12A depicts measured X-axis component from coupled X-Y axis excitation;
Second image 1200B in FIG. 12B depicts measured X-axis component from coupled X-Z axis excitation;
Third image 1200C in FIG. 12C depicts measured Y-axis component from coupled X-Y axis excitation;
Fourth image 1200D in FIG. 12D depicts measured Y-axis component from coupled Y-Z axis excitation;
Fifth image 1200E in FIG. 12E depicts measured Z-axis component from coupled X-Y axis excitation; and
Sixth image 1200F in FIG. 12F depicts measured Z-axis component from coupled Z-Y axis excitation.

TABLE 2
Performance of Prototype Tri-Axial Accelerometer Sensor

| | In-Plane | | Out-of-Plane |
|---|---|---|---|
| | Measurement | | Measurement |
| | X-Axis | Y-Axis | Z-Axis |
| Measurement Range (g) | ±50 | | |
| Sensor Sensitivity (fF/g) | 10.5 | 16.4 | 3.0 |
| Resolution (mg) | 2.8 | 1.8 | 10.0 |
| Spring Stiffness (μN/μm) | 23.4 | 38.7 | 51.8 |
| Resonant Frequency (kHz) | 4.3 | 4.1 | 8.3 |
| Mechanical Noise (μg/\sqrt{Hz}) | 1.04 × 10⁻² | 0.1415 | 19.2 |
| Cross-Axis Sensitivity (%) | 1.3 | 0.86 | 1.05 |

| | |
|---|---|
| Dimensions (μm³) | 1000 × 1000 × 30 |

As noted supra low noise operation is an important parameter in the specification of an accelerometer. The noise floor is mainly established by two factors, the signal conditioning circuit and the mechanical noise within the accelerometer. The former is generally considered external to the accelerometer even where the MEMS accelerometer is integrated with a CMOS circuit as the electrical circuit design drives its electrical noise. The latter arises from the air viscosity inside the accelerometer package. The noise spectral density referred to the input acceleration is given by Equation (9) where k_{B}, T, and Q are the Boltzmann constant, the working temperature and the quality factor, respectively.

$${a}_{n} = \sqrt{\frac{4 {k}_{B} T {ω}_{n}}{Q}} \qquad ( 9 )$$

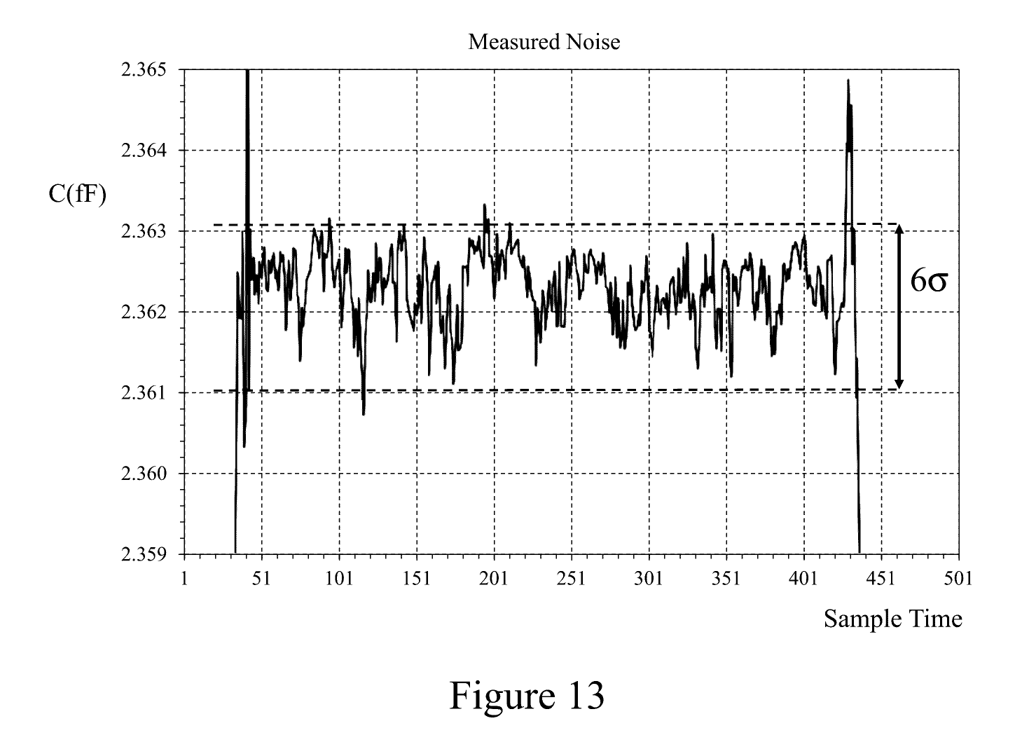

Amongst the features of the commercial MIDIS process to facilitating low noise performance are that it includes a pair of unique features that are not currently available through any other commercial MEMS foundry. The first of these is that a thick structural device wafer of 30 μm adds significant mass, and the second is the ultra-clean wafer level vacuum encapsulation at 10 mTorr which leads to a high Q factor through reduction in the damping effect. Experimentally, a total equivalent noise (TENA) measurement of an accelerometer is performed under 1 g input acceleration and is deduced from the 6σ uncertainty of the electrical output as depicted in FIG. 13. Accordingly, for the Y-axis of a novel tri-axial accelerometer according to an embodiment of the invention this measurement yielded a result of approximately 0.33 [symbol] F which leads to an acceleration resolution of 1.8 mg for a given bandwidth of 32 Hz. Referring to FIG. 13 it is evident that the data near the start and end shows a large signal variation due to the tilting of test chip to collect suitable data. As predicted through the damping mechanism, in the current design the dominant mechanical noise is generated along Z-axis and it is estimated to be 19.2 μg/\sqrt{Hz}. As evident from Table 2 the mechanical noise on the X- and Y-axes was significantly lower. By comparison a commercial 3-axis accelerometer, a Dytran 7503A5 High Precision tri-axial MEMS accelerometer which achieves 75 μg/\sqrt{Hz} such that the inventive accelerometer of the inventors has only 25% of the mechanical noise on its worst axis, the Z-axis, and is orders of magnitude lower in mechanical noise on the X- and Y-axes. Equally cross-axis sensitivity is at worst 45% that of the commercial MEMS device.

Accordingly, the inventors have presented the design, fabrication and testing of a wafer level vacuum encapsulated tri-axial capacitive accelerometer with low cross-axis sensitivity. The novel accelerometer is fabricated using a commercial MEMS foundry process provides a promising option allowing highly efficient and reproducible manufacturing at large volumes, lower cost, and high yields. The wafer level vacuum encapsulation of the novel accelerometer provides benefits in reducing the overall product cost, simplifying packaging constraints, and easing supply-chain logistics. The novel accelerometer includes several novel features including:
integrated structure using decoupled frames supported by strategically designed springs; and
capacitive compensators for the purpose of achieving low cross-axis sensitivity.

It would be evident that whilst accelerometers have been described performing measurements in 3 axes it would be evident that the design principles embodied in the invention may be applied to accelerometers performing measurements in 1 axis or 2 axes.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A device comprising:
a substrate;
a microelectromechanical system (MEMS) comprising a plurality of integer N frames disposed within each other with the inner N−1 frames being suspended with respect to the substrate, the outermost frame attached to the substrate, and the innermost frame providing a proof mass;
a plurality of N−1 sets of springs, each set of springs being of a predetermined design and attached from a first predetermined frame of the plurality of N frames to a second predetermined frame of the plurality of N frames;
a plurality of M comb drive pairs, each comb drive pair comprising first and second comb drives attached at opposite sides of a third predetermined frame of the plurality of N frames to a fourth predetermined frame of the plurality of N frames.

2. The device according to claim 1, wherein
N=4 and M=2; and
the device provides variations in capacitance for three orthogonal axes relative to the device, wherein one of these three orthogonal axes is perpendicular to and out of plane of the device.

3. The device according to claim 1, wherein
a first comb drive pair of the M comb drive pairs attached to the outermost frame and the first suspended frame within the outermost frame; and
a second comb drive pair of the M comb drive pairs attached to the first suspended frame within the outermost frame and the second suspended frame disposed within the first suspended frame.

4. The device according to claim 1, wherein
at least one of the comb drive pairs of the plurality of M comb drive pairs employs a moving comb comprising a plurality of first fingers and a fixed comb comprising a plurality of second fingers wherein the plurality of first fingers and plurality of second fingers are each disposed along a first axis of the device and are designed such that positional variations arising from motion in the axes perpendicular to the first axis do not result in a change in capacitance of the comb drive pair.

5. The device according to claim 1, wherein
the innermost suspended frame of the plurality of N frames is suspended from the penultimate inner frame of the plurality of frames by a first set of springs of a first predetermined design; and
each inner frame of the plurality of frames except the innermost suspended frame is suspended by a second set of springs of a second predetermined design, wherein
the first predetermined design has low resistance to motion out of plane of the device from the proof mass; and
the second predetermined design has high resistance to motion out of plane of the device.

6. The device according to claim 1, wherein
the innermost suspended frame of the plurality of N frames is suspended from the penultimate inner frame of the plurality of frames by a first set of springs of a first predetermined design with each spring of the first set of springs is disposed on a side of the innermost suspended frame; and
each inner frame of the plurality of frames except the innermost suspended frame is suspended by a second set of springs of a second predetermined design with the springs of the second set of springs disposed in pairs on opposite sides of pair of frames they are connected to.

7. The device according to claim 6, wherein
the sides of the inner frame of the pair of frames to which the second set of springs are attached are shorter sides of that frame; and
the side of the outer frame of the pair of frames to which the second set of springs are attached are longer sides of that frame.

8. The device according to claim 1, wherein
the innermost frame of the plurality of N frames is square; and
each frame of the plurality of N frames between the innermost frame and outermost frame is rectangular with its longer axis along an axis of the device along which that frame is designed to oscillate.

9. A device comprising:
a fixed frame;
a first frame disposed within an opening within the fixed frame connected to the fixed frame by a plurality of first springs;
a second frame disposed within an opening within the first frame connected to the first frame by a plurality of second springs;
a proof mass disposed within an opening within the second frame connected to the second frame by a plurality of third springs; wherein
each of the first and second frames have a first axis of the respective frame longer than a second axis of the respective frame and the first axes of the first and second frames are orthogonal to each other.

10. The device according to claim 9, wherein
the proof mass provides a varying capacitance relative to the second frame under motion of the proof mass in a first direction;
the second frame provides a varying capacitance relative to the first frame under motion of the second frame in a second direction orthogonal to the first direction; and
the first frame provides a varying capacitance relative to the fixed frame under motion of the first frame in a third direction orthogonal to the first and second directions.

11. The device according to claim 9, wherein
the proof mass forms a capacitor with an electrode disposed substantially parallel to it, wherein the electrode has dimensions larger than that of the proof mass determined in dependence upon the motion of the proof mass in at least one axis in the plane of the proof mass arising from acceleration along the at least one axis.

12. The device according to claim 9, wherein
the motion of adjacent frames within the device leads to a differential capacitive variation arising from interdigitated capacitor structures disposed along adjacent edges of the adjacent frames and cross-axis sensitivity is reduced by having the fingers on one of the adjacent frames with reduced height relative to the fingers on the other of the adjacent frames such that motion out of the plane of the frames does not result in a capacitive variation with a predetermined range of motion, wherein the reduced height is determined in dependence upon said predetermined range of motion.

13. The device according to claim 9, further comprising
an inter-digitized compensation capacitor which has constant capacitance irrespective of motion within a predetermined axis of the second frame in order to reduce cross-axis sensitivity of the device.

14. A method comprising:
linking a proof mass to a first frame by a plurality of first springs that support motion of the proof mass out of the plane within which the proof mass and the plurality of first springs are manufactured;
linking the first frame to an outer frame by a plurality of second springs that support motion of the first frame in the plane within which the first frame and the plurality of second springs are manufactured; an
providing a pair of drive combs attached to the outer frame.

15. The method according to claim 14; wherein
the drive combs are designed such that movement of a moving comb forming part of the drive comb relative to a fixed comb forming another part of the drive comb in each orthogonal axis to an axis the drive comb operates in has minimal impact to the capacitance of the drive comb.

16. The method according to claim 14, wherein
each first spring comprises a pair of mounts connected via a serpentine element, wherein the pair of mounts are on opposite ends of the serpentine and the serpentine extends laterally either side of an axis through the pair of mounts.

17. The method according to claim 14, wherein
each second spring comprises a pair of mounts connected via a serpentine element, wherein the pair of mounts are on opposite ends of the serpentine and the serpentine extends laterally one one side of an axis through the pair of mounts.
